(19) United States
(12) Patent Application Publication
(10) Pub. No.: US 2011/0290757 A1
(43) Pub. Date: Dec. 1, 2011

(54) CONTAINER OXYGEN-SCAVENGING APPARATUS AND METHODS OF USE

(75) Inventor: Vernon J. Purdy, Ajijic (MX)

(73) Assignee: VJP LIMITED, Laredo, TX (US)

(21) Appl. No.: 12/790,187

(22) Filed: May 28, 2010

(51) Int. Cl. B65D 39/00; B23P 11/00

(52) U.S. Cl. 215/364; 29/428

(57) ABSTRACT

An oxygen-scavenging apparatus is disclosed that can easily be applied by an end user to the bottom of a wine-bottle cork, or other food or beverage container that is sealed with a container-stopper device, such as a synthetic cork or a screw-type cap. The oxygen-scavenging apparatus is easily attachable and detachable, and relies on a friction-based fastener for its coupling to the container stopper. In some embodiments, the apparatus can serve a dual purpose by both scavenging oxygen and by absorbing moisture by using both oxygen-scavenging compound and desiccant material. The oxygen-scavenging apparatus is simple in design and thus relatively easy and cost-effective to manufacture.

### BACKGROUND OF THE INVENTION

Occasional/moderate drinkers of wines commonly find themselves investing in a bottle of wine, yet not finishing the bottle of wine in one sitting. Consequently, the partially-consumed bottle of wine is usually resealed with its original stopper for later consumption. The bottle stopper is usually a cork made from the resiliently-compressible bark of the cork tree, although some bottled wines are now sealed using stoppers made from various types of elastomers, as well as by screw-top caps. The design of the bottle stopper needs to be such as to effectively seal the contents within the bottle from the atmosphere in order to prevent spoilage of the bottle contents. Exposure to oxygen is a major concern since it leads to oxidation of wine, which causes wine to become acidic and unpalatable.

Unfortunately for the occasional wine drinker, if too much time elapses between the first opening of the wine and the subsequent reopening and consumption of the balance of the wine, the taste and quality of the wine is often compromised due to the effects of oxidation of the liquid contents. This is because the substantial volume of air introduced into the bottle when it was first opened, used, and resealed has been trapped with the liquid contents and allowed time to chemically interact. Consequently, the shelf life of a partially used bottle of wine is relatively short, and the consumer's investment is largely wasted.

Some remedies propose to use a bottle-top mountable pump to evacuate the bottle through a sealable closure that acts as a one-way valve. By evacuating the air from within the bottle in this way, the shelf-life of the half consumed bottle is at best extended by just a few days. Moreover, this method often proves to be laborious and clumsy—as well as often fails to work very well, if at all.

Another remedy fills the void of the part-emptied wine bottle with inert gas, which is impractical because the seal over the wine (or other oxidizable beverage) in the bottle is vulnerable to being broken by any agitation of the bottle and because this solution is generally ineffective when the bottle is under half full. Moreover, sparkling wines cannot generally be preserved by this method.

Other remedies in the art introduce oxygen-scavenging compounds into the interior of a container to interact with molecular oxygen (O₂) present in the container. Molecular oxygen can be present in the form of a variety of highly reactive intermediate species by the addition of one to four electrons. The carbon-carbon double bonds found in virtually all foods and beverages are particularly susceptible to reaction with these intermediate species. The resulting oxidation products adversely affect the performance, odor, and/or flavor of the food or beverage. Consequently, materials or compounds are used to remove oxygen from the interior closed packages either by reacting or combining with entrapped oxygen, or by promoting an oxidation reaction that yields innocuous products.

Much work has been done to incorporate oxygen scavengers in food and beverage containers, especially in polymers used for plastic containers or container caps and stoppers. Among the categories of oxygen scavengers used in industry are iron-based, sulfite-based, ascorbate-based, and enzyme-based systems. Other options in the art include oxidizable polyamides and ethylenically unsaturated hydrocarbons, among others. However, this patent application does not seek to recite the myriad oxygen-scavenging compounds available in the food and beverage industry; rather, the inventive disclosures herein are directed to the introduction of the oxygen scavenger of choice to a food or beverage container.

Returning to the partially used bottle-of-wine problem, some remedies use some such oxygen-scavenging compounds by impregnating a synthetic cork with them, as is discussed in U.S. Pat. No. 4,188,457 to Throp (Throp). Throp discloses a thermoplastic cork with a core containing an oxygen-scavenging compound and with a liquid-impervious skin. This proposal requires that wine producers either seal their products using this non-traditional cork, or end users somehow obtain such a synthetic cork to insert into their partially used bottles of wine. The idea of not using a traditional cork for a bottle of wine is undesirable to many wine drinkers, impacting ambiance, tradition, etc.

Other references offer solutions proposing some sort of synthetic cork, which largely suffer from the same disability as in Throp. For example:
Patent Cooperation Treaty (PCT) Application Publication No. WO2008010818A1 to Weng (Weng), which discloses a cork for a sealed container, such as a wine bottle, that uses a polymer cork, which has contained within it oxygen-scavenging capabilities. The polymer cork has a skin layer to isolate the oxygen-scavenging compound from bleeding into the wine.
U.S. Pat. No. 6,911,171 to Lauer (Lauer) discloses yet another multi-layer synthetic cork, in which an oxygen-scavenging agent is incorporated in the manufacture of the synthetic cork.
Japanese Patent Application Publication No. 2005035596A2 to Takahiro (Takahiro) discloses a container stopper comprised of a thermoplastic resin with impregnated with an oxygen-scavenging agent, with the thermoplastic resin separated from the liquid with an isolating layer.
PCT Application Publication No. WO8001559A1 to Throp (Throp-II) discloses a closure for a container to replace a cork. The closure member contains a core with an oxygen scavenger compound.
PCT Application Publication No. WO0026103A1 to Zech et al. (Zech) discloses another synthetic cork which can incorporate oxygen-scavenging agents in the polymers that comprise the stopper.

Many proposed solutions involve relatively complex mechanical designs for container stoppers that are impracticable from a manufacturing cost and/or marketing aspect. These types of solutions are both relatively expensive to manufacture and complex, as well as suffer from the same disability as in Throp regarding tradition and ambiance. For example:
U.S. Patent Application No. US20080272985A1 to Laporta (Laporta) discloses a bottle stopper designed to both seal and scavenge oxygen from the contents of the container it is used with. However, this particular device is a complex mechanical solution with many parts, including a plunger assembly that when engaged to cause a sealing of the container (via expanding O-rings) also causes a pathway to open to an internal chamber that contains the oxygen-scavenging medium.
U.S. Pat. No. 6,772,892 to Flesher (Flesher) discloses a reusable closure system for bottle containers, which can incorporate an oxygen scavenger impregnated in the polymer of the plug/compression disk.

Other proposed solutions involve a type of bottle/container cap that is fabricated with oxygen-scavenging compound incorporated within it, with the oxygen-scavenging compound isolated from liquid contents via gas-permeable film that is also water-impermeable. These solutions are generally unacceptable for those in the wine industry (and their consumers) for the same reason the Throp solution is unacceptable to many. For example:
U.S. Pat. No. 4,287,995 to Moriya (Moriya) essentially discloses a bottle cap that has, as an integral component, a chamber containing an oxygen-scavenging medium sealed from the contents of the container by way of a gas-permeable film that is also water-impermeable.
U.S. Patent Application Publication No. US20080251491A1 to Krautkramer (Krautkramer) discloses a closing cap for containers that also has an oxygen-scavenging compound coated around the annular circumferential seal. The annular seal is formed in one piece with the closure cap, including the oxygen-scavenging coating.
U.S. Pat. No. 4,840,280 to Schvester (Schvester) also essentially discloses a bottle cap with a sealed-yet-gas-permeable packing.
U.S. Pat. No. 4,756,436 to Morita (Morita) yet another bottle cap that contains a chamber with an oxygen scavenger separated from the contents of the container via a gas-permeable layer.
European Patent Application Publication No. 1991-11-06 to Edens (Edens) discloses the coating of crown corks (essentially a bottle cap) with thin layers of yeast-bearing materials such as paraffin or wax, the purpose of said coating is to reduce the oxygen concentration of the container contents.

Finally, one of the more relatively unorthodox solutions proposed is in PCT Application Publication No. WO03008276A2 to Amisar (Amisar), which discloses the introduction of an oxygen-scavenging compound contained within a membrane, which is contained within a device designed to float at the gas-liquid interface in the container. That is, the oxygen scavenger device is not a part of the container stopper.

What is needed is a means to easily and economically allow consumers of wine to increase the shelf life of partially consumed bottles of wine by scavenging oxygen without compromising the traditional experiences and expectations that go with the opening a fine bottle of wine. Presumably, such a solution could also be applied to the containers of other type of beverages and food products.

### BRIEF DESCRIPTION OF THE DRAWINGS

FIG. 1 depicts an isometric view of one embodiment of an oxygen-scavenging apparatus with a fastener end that is frictional in nature and resembles that of a dual-pronged push-pin.

FIG. 2 depicts a side, cutaway view of the embodiment of an oxygen-scavenging apparatus shown in FIG. 1, wherein the cut-away view shows the main body of the apparatus as being comprised of oxygen-scavenging compound, while being surrounded by an optional layer of a gas-permeable, liquid impermeable layer. This optional layer is exaggerated in thickness for illustrative purposes.

FIG. 3 depicts an isometric view of one embodiment of an oxygen-scavenging apparatus with a fastener end that is frictional in nature and resembles that of a cork screw.

FIG. 4 depicts a side, cutaway view of the embodiment of an oxygen-scavenging apparatus shown in FIG. 3, wherein the cut-away view shows the main body of the apparatus as being comprised of oxygen-scavenging compound, while being surrounded by an optional layer of a gas-permeable, liquid impermeable layer. This optional layer is exaggerated in thickness for illustrative purposes.

FIG. 5 depicts an isometric view of one embodiment of an oxygen-scavenging apparatus with a fastener end that is adhesive in nature.

FIG. 6 depicts a side, cutaway view of the embodiment of an oxygen-scavenging apparatus shown in FIG. 4, wherein the cut-away view shows the main body of the apparatus as being comprised of oxygen-scavenging compound, while being surrounded by an optional layer of a gas-permeable, liquid impermeable layer. This optional layer is exaggerated in thickness for illustrative purposes.

FIG. 7 depicts an isometric view of one embodiment of an oxygen-scavenging apparatus with enhanced surface areas to improve oxygen scavenging operations. In this embodiment, the oxygen-scavenging member is shaped somewhat like a common wing nut (though many other shapes with fin-type members are possible). This embodiment also depicts a fastener end that is frictional in nature and resembles that of a wood screw.

FIG. 8 depicts a side, cutaway view of the embodiment of an oxygen-scavenging apparatus shown in FIG. 7, wherein the cut-away view shows the main body of the apparatus as being comprised of oxygen-scavenging compound, while being surrounded by an optional layer of a gas-permeable, liquid impermeable layer. This optional layer is exaggerated in thickness for illustrative purposes.

FIG. 9 depicts the orientation of an embodiment of an oxygen-scavenging apparatus, according to either FIG. 1, 3, or 5, relative to a liquid-containing bottle with a stopper such as a cork.

FIG. 10 depicts the installation of an embodiment of an oxygen-scavenging apparatus, according to either FIG. 1, 3, or 5, in a stopper such as a cork within a liquid-containing bottle.

FIG. 11 depicts the orientation of an embodiment of an oxygen-scavenging apparatus, according to FIG. 7, relative to a liquid-containing bottle with a stopper such as a cork.

FIG. 12 depicts the installation of an embodiment of an oxygen-scavenging apparatus, according to FIG. 7, in a stopper such as a cork within a liquid-containing bottle.

### DETAILED DESCRIPTION

### Overview

The various embodiments of the invention encompass a small, easily manufactured, apparatus for scavenging oxygen in a container of beverage or food that has been initially opened, thus breaking the container seal and introducing outside air to the contents, and then resealed. A basic embodiment of the apparatus is an injection-molded oxygen-scavenging member (though in some embodiments, it can be at least partially machined) comprised primarily of an effective oxygen-scavenging compound (as are abundantly available in the art), coupled with a means for a consumer to fasten the member to the bottom of a container cork, stopper, or cap (for convenience, all three can be referred to as a “container stopper”) before replacing the container stopper onto the opened container.

In many embodiments, the oxygen-scavenging member of the apparatus is manufactured with a coating of a material that is both gas permeable and liquid impermeable in order to prevent contamination of the wine from “bleeding” of oxygen-scavenging compound from the apparatus.

In some embodiments, the oxygen-scavenging member is a polymeric container of a small chamber in which is disposed an effective oxygen-scavenging compound, wherein the polymeric chamber has a plurality of pinholes to facilitate the interaction between gases in the container and the oxygen-scavenging compound. In some embodiments, the apparatus is designed to have an oxygen-scavenging capacity for a one-time use after which the apparatus is discarded. In other embodiments, the apparatus is designed to have a higher oxygen-scavenging capacity such that the apparatus can be reused multiple times for multiple containers of food or beverage.

In still other embodiments, the oxygen-scavenging apparatus can have at least two chambers, where one chamber contains and oxygen-scavenging compound, and another chamber contains a desiccant material for absorbing unwanted moisture in the container air, thus forming a dual-purpose apparatus. This is particularly useful for embodiments that are applied for food-storage containers where the presence of moisture is harmful to contained dry foodstuffs. In a related embodiment, the oxygen-scavenging apparatus has single a chamber that can facilitate the change-out of oxygen-scavenging compound with desiccant material, and vice-versa. Alternatively, both oxygen-scavenging compound and desiccant material can be stored within the same chamber, forming a dual-purpose apparatus.

A basic embodiment includes fastener means such as a tack-type needle or a screw member (such as wood-screw threads or cork-screw threads). In some embodiments, the fastener means can even be implemented by using a simple food-safe adhesive between the oxygen-scavenging apparatus and the bottom of the container stopper. After opening a new bottle of wine, a user can merely apply the fastener means of the oxygen-scavenging apparatus directly to the bottom of the wine-bottle container stopper, then replace the container stopper in the bottle of wine to increase the effective shelf life of the wine contained therein. If a synthetic container stopper is used, it is assumed that the material used can be penetrated by the friction-type fastener means of the oxygen-scavenging apparatus.

In still other embodiments, the oxygen-scavenging member of the apparatus incorporates an oxygen-indicator member that provides a color indicator when molecular oxygen is present or absent in the container. Thus, the oxygen-indicator member helps prove the efficacy of the apparatus without opening the container.

For container's of liquid, such as a bottle of wine, the oxygen-indicator member can also be used to tell a user when it is appropriate to place the container on its side, as is the custom for many people who store wines. This is because the oxygen-scavenging member is largely useless when submerged in the bottle's liquid contents. Thus, with a partially used bottle of wine in the upright position, the oxygen-scavenger, which is typically disposed in the gaseous portion of the bottle contents, can effectively scavenge molecular oxygen. After the oxygen-indicator member changes color to indicate the absence of molecular oxygen, the bottle can be stored on its side, because if the liquid contents are still high enough to submerge the oxygen-scavenging apparatus when the bottle of wine is stored on its side, then the apparatus will not be effective.

For exemplary purposes only, the detailed description provided herein largely focuses on the application of the inventive concept in the field of bottled wines. It would be appreciated by those ordinarily skilled in the food or beverage industry that the inventive concepts and implementations described herein can easily be applied to myriad similar applications beyond the application to bottles of wine.

By preventing oxidizing of the contents of the wine bottle, the apparatus allows a consumer of wines to save unused quantities of wine in a bottle for a much longer period of time, while maintaining the quality of taste and while maintaining the ability to use a traditional wine cork, including enjoying the tradition and ambiance associated therewith.

### Terminology

The terms and phrases as indicated in quotes (“ ”) in this section are intended to have the meaning ascribed to them in this Terminology section applied to them throughout this document, including the claims, unless clearly indicated otherwise in context. Further, as applicable, the stated definitions are to apply, regardless of the word or phrase's case, to the singular and plural variations of the defined word or phrase.

The term “or”, as used in this specification and the appended claims, is not meant to be exclusive; rather, the term is inclusive, meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of the phrase “in one embodiment” and/or “in one variation” in various places in the specification are not necessarily all meant to refer to the same embodiment.

The term “couple” or “coupled”, as used in this specification and the appended claims, refers to either an indirect or a direct connection between the identified elements, components, or objects. Often the manner of the coupling will be related specifically to the manner in which the two coupled elements interact.

The term “removable”, “removably coupled”, “readily removable”, “readily detachable”, and similar terms, as used in this patent application specification (including the claims and drawings), refer to structures that can be uncoupled from an adjoining structure with relative ease (i.e., non-destructively and without a complicated or time-consuming process) and can also be readily reattached or coupled to the previously adjoining structure.

Directional and/or relational terms such as, but not limited to, left, right, nadir, apex, top, bottom, vertical, horizontal, back, front, and lateral are relative to each other, are dependent on the specific orientation of an applicable element or article, are used accordingly to aid in the description of the various embodiments, and are not necessarily intended to be construed as limiting.

As applicable, the terms “about” and “generally” as used herein unless otherwise indicated means a margin of +−20%. Also, as applicable, the term “substantially” as used herein unless otherwise indicated means a margin of +−10%. It is to be appreciated that not all uses of the above terms are quantifiable such that the referenced ranges can be applied.

An “oxygen scavenger” or “oxygen-scavenging compound” as used herein is any material or compound that can remove oxygen from the interior of a closed package either by reacting or combining with the entrapped oxygen, or by promoting an oxidation reaction that yields innocuous products.

The term “stopper” or “container stopper” as used herein is intended to be a generic term for a manufactured device for sealing the design opening of a container in order to isolate the contents therein from the outside environment. Therefore, the term “stopper” or “container stopper” can mean a synthetic-material container stopper, a bottle cork, or a screw-type container cap, unless otherwise specifically limited.

### First Embodiment

### An Apparatus for Scavenging Oxygen in a Partially Used, Resealed Container Of Food Or Beverage

This embodiment is directed generally to an easily installed and removable oxygen-scavenging device that is affixed to container stopper, such as a cork, of a bottle of wine. This embodiment is directed to a bottle of wine for exemplary purposes only, as the oxygen-scavenging apparatus can be just as easily used in conjunction with the stopper of myriad other types of containers of foods and/or beverages.

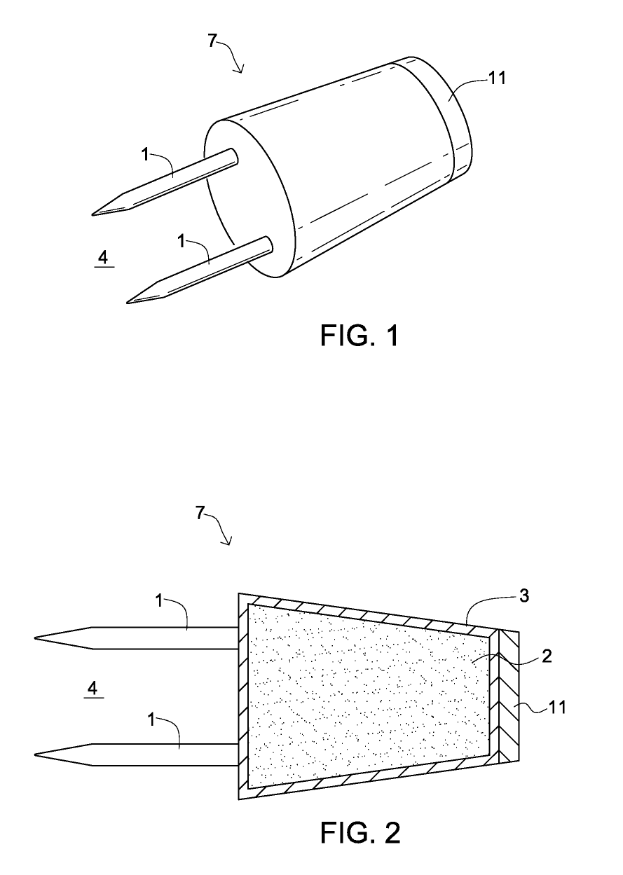

Refer to FIGS. 1 and 2, which depict one basic embodiment of a detachable, container-stopper, mounted, oxygen-scavenging apparatus. The apparatus comprises an oxygen-scavenging member 7, which is primarily made from a polymer which incorporates an oxygen-scavenging compound 2. Examples of such polymers with incorporated oxygen-scavenging compounds are prevalent in the art and are also discussed in many of the existing-art references discussed in the Background Section, including Patent Cooperation Treaty (PCT) Application Publication No. WO2008010818A1 to Weng, Japanese Patent Application Publication No. 2005035596A2 to Takahiro, PCT Application Publication No. WO0026103A1 to Zech et al., and U.S. Pat. No. 6,772,892 to Flesher.

In many embodiments, and depending on the type of oxygen-scavenging compound 2 used, a gas-permeable, liquid-impermeable layer 3 coats the oxygen-scavenging compound 2, which helps prevent oxygen-scavenging compound 2 from “bleeding” into the contents of a container 5, while allowing the gases in the container 5, including and especially molecular oxygen, to chemically interact with the oxygen-scavenging compound 2. FIG. 2 shows this optional layer 3 with an exaggerated thickness for illustrative purposes. Once again, examples of materials are prevalent in the art and are also discussed at length in many of the existing-art references that are discussed in the Background Section supra, including PCT Application Publication No. WO2008010818A1 to Weng, U.S. Pat. No. 6,911,171 to Lauer, Japanese Patent Application Publication No. 2005035596A2 to Takahiro, PCT Application Publication No. WO8001559A1 to Throp, U.S. Pat. No. 4,287,995 to Moriya, U.S. Pat. No. 4,840,280 to Schvester, and U.S. Pat. No. 4,756,436 to Morita.

In still other embodiments, the oxygen-scavenging member 7 of the apparatus incorporates an oxygen-indicator member 11 that provides a color indicator when molecular oxygen is present in the container. The oxygen-indicator member 11 can be attached to any surface of the oxygen-scavenging member 7 that is substantially exposed to the gaseous contents in the container 5. The oxygen-indicator member 11 is comprised of a food-safe composition such that the oxygen-indicator member 11 turns color (in some embodiments, for example, from pink to blue as the concentration of molecular oxygen increases), similar to a litmus indicator. Such materials, which can involve polymeric compositions, are well-known in the art. For example, some candidate materials are disclosed in U.S. Pat. No. 5,839,592 to Hayes, U.S. Pat. No. 4,511,052 to Klein et al., and U.S. Pat. No. 4,349,509 to Yoshikawa et al; however, this list of prior-art disclosures of such oxygen-indicating materials is not intended to be a limiting list. In the embodiments that use an oxygen-indicator member 11, the major limitation is that the color-changing oxygen-indicator member 11 be made of food-safe materials. Further examples of such materials currently used in the market include Tell-Tab™ Oxygen Indicator and Dry Pak™ Reversible Oxygen Indicators. It should be noted, however, that color-changing oxygen-indicator members 11 will have little practical use for substantially opaque containers 5.

In some embodiments, the oxygen-scavenging member 7 is a polymeric container 3 of a small chamber in which is disposed an effective oxygen-scavenging compound 2, wherein the polymeric chamber has a plurality of pinholes to facilitate the interaction between gases in the container and the oxygen-scavenging compound 2. In one example embodiment, an iron-based scavenging compound is used, and is contained within a soft iron foil within the chamber of the oxygen-scavenging member 7, which is perforated. In other embodiments, more high-end (that is, expensive) versions of this embodiment use a stainless-steel or gold-plated chamber that incorporate a resealable opening to allow the replacement of oxygen-scavenging compound 2. Such a resealable opening can be a threaded cap or a cap that attaches to the chamber via an interference fit. In some embodiments, the cap providing access to the chamber also houses the oxygen-indicator member 11, which also facilitates the replacement of a depleted oxygen-indicator member 11.

In still other embodiments, the oxygen-scavenging member 7 can have at least two chambers, where one chamber contains and oxygen-scavenging compound, and another chamber contains a desiccant material for absorbing unwanted moisture in the container air, thus forming a dual-purpose apparatus. This is particularly useful for embodiments that are applied for food-storage containers where the presence of moisture is harmful to contained dry foodstuffs. In a related embodiment, the oxygen-scavenging member 7 has single a chamber that can facilitate the change-out of oxygen-scavenging compound with desiccant material, and vice-versa. Alternatively, both oxygen-scavenging compound and desiccant material can be stored within the same chamber, forming a dual-purpose apparatus. In still more embodiments, the chamber(s) can be opened and resealed via a threaded or interference-fit cap described supra to facilitate the replacement of depleted oxygen-scavenging compound 2 and/or desiccant material.

In some embodiments, the oxygen-scavenging member 7 of the apparatus is designed to have an oxygen-scavenging capacity for a one-time use after which the apparatus is discarded. In other embodiments, the oxygen-scavenging member 7 of the apparatus is designed to have a higher oxygen-scavenging capacity such that the apparatus can be reused multiple times for multiple containers of food or beverage.

Attached to the oxygen-scavenging member 7 is a fastener-end member 1, which in many embodiments is at least one tack-type friction member made from hardened plastic or from metal. In many embodiments, the fastener-end member 1 is a dual-pronged tack-type friction member, whereby the dual friction members add reliability in the attachment of the oxygen-scavenging apparatus 7 to the bottom of a container stopper. While any suitable type of metal may be used for the fastener-end member 1 prongs, the use of corrosion-resistant metals, such as stainless steel, is preferred. Otherwise, the corrosion of the metal fastener-end member 1 could introduce metallic ions into the container contents. The fastener-end member 1 is sized such that it would not breach the integrity of an attached container stopper when the fastener-end member 1 is fully engaged with the container stopper.

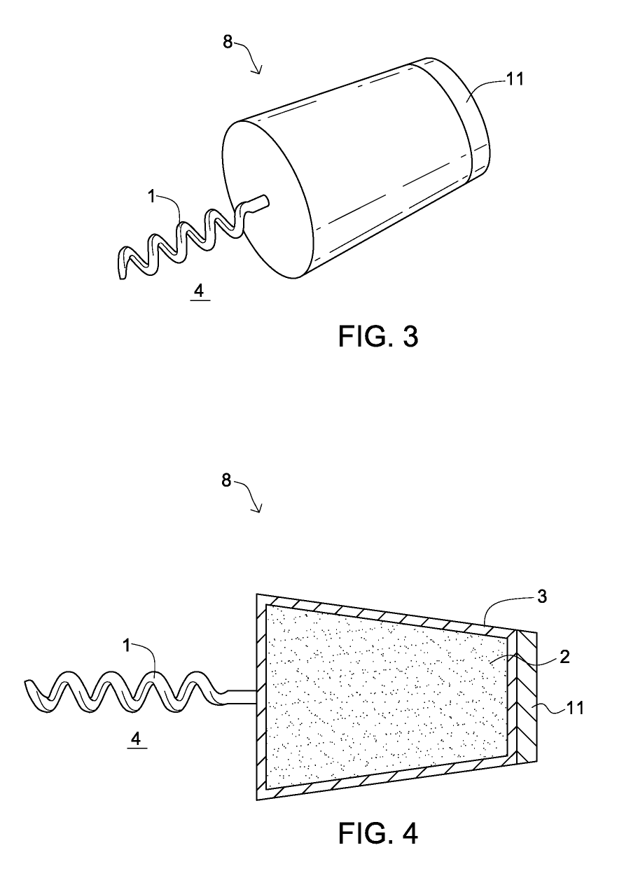

In other embodiments, the fastener-end member 1 is a screw-type friction fastener type, shaving threads similar to that of a common wood screw or of a small cork screw. See, for example, FIGS. 3-4 and 7-8. This type of fastener-end member 1 might be more desirable for applications where the oxygen-scavenging apparatus 8, 10 is being installed in a traditional wine cork, where the threads would help inhibit the apparatus from unintentionally dislodging and falling into the contents of the wine bottle.

If a synthetic container stopper is used, it is assumed that the stopper material used can be penetrated by the friction-type fastener means 1 of the oxygen-scavenging apparatus 7, 8, 10, for embodiments so equipped.

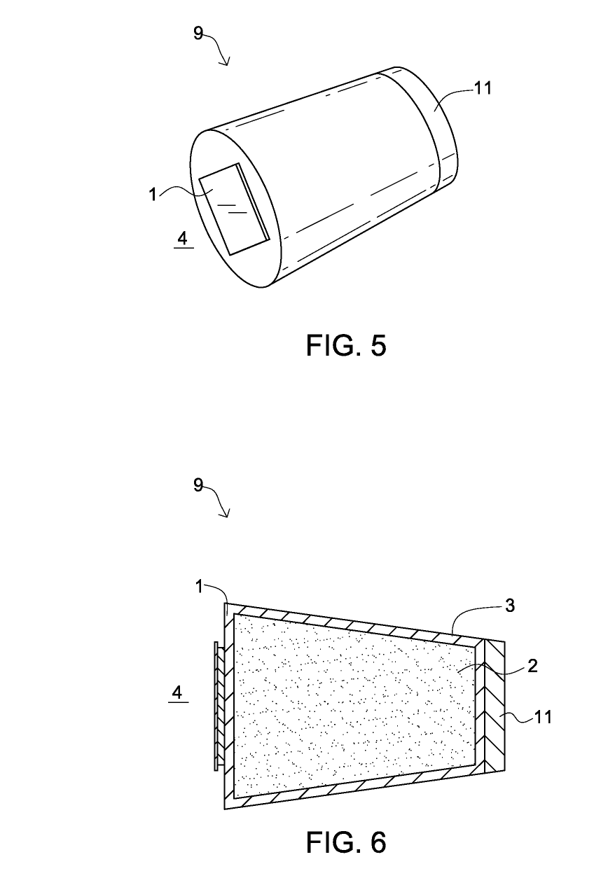

In some embodiments, the fastener-end member 1 is largely comprised of a simple food-safe adhesive 1 (see FIGS. 5-6) between the oxygen-scavenging apparatus 9 and the bottom of the container stopper.

The shape and size of the oxygen-scavenging member 7, 8, 9, 10, arising from the base at which the fastener-end member is coupled, can vary widely and still be effective. It is desirable to remove molecular oxygen from the gaseous contents of a container as quickly as possible in order to minimize the chance that the contents are spoiled due to the interaction with the molecular oxygen. Generally speaking, the size of the oxygen-scavenging member 7, 8, 9, 10 should be large-enough to provide enough surface area to efficiently interact with the gaseous contents of the container the apparatus is being used in, as well as large-enough to allow a user to grasp the oxygen-scavenging member 7, 8, 9, 10 between his or her fingers to allow the installation or removal of the apparatus with respect to the container stopper. Of course, if the oxygen-scavenging member 7, 8, 9, 10 is too large, it may not fit through the opening of a container when reinstalling the container stopper and/or may have far too much oxygen-scavenging material than is necessary, which is both a waste and also increases the chance of such oxygen-scavenging material bleeding into the contents of the container.

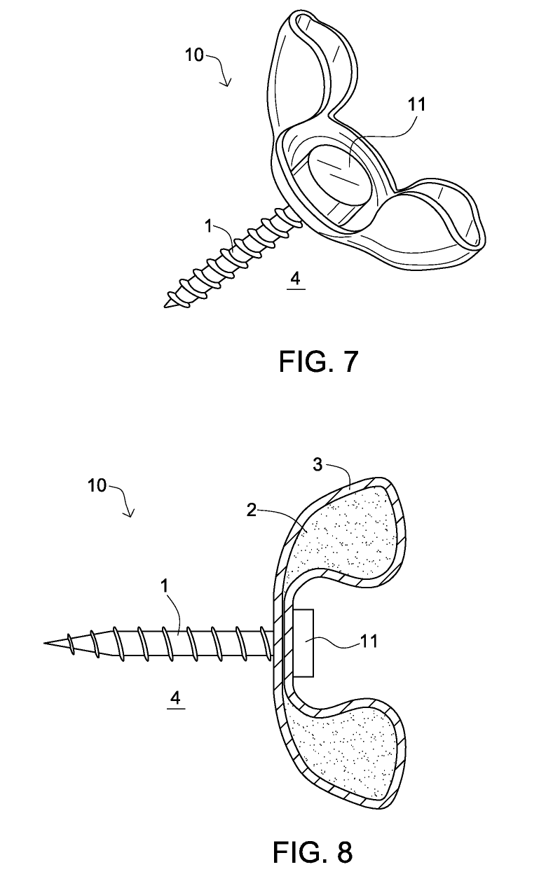

Refer to FIGS. 1-8. In some embodiments, the shape of the oxygen-scavenging member 7, 8 can be somewhat barrel or cylindrical shaped. In the case of the exemplary embodiments in FIGS. 1-6, the shape of the oxygen-scavenging apparatus overall can resemble a common plastic, bulletin-board push-pin (though this embodiment of the apparatus can have one or more friction-fastener members), which would be easy and relatively inexpensive to fabricate. In applications where it is desired to more-efficiently scavenge oxygen by having greater exposed surface areas to the internal environment of a container's gases, a different shape and size may be called for in some embodiments. For example, one or more structures resembling a “blade” or “fin” of sorts can be fabricated to comprise a substantial portion of the oxygen-scavenging member 10. Such a shape also would have the benefit of providing a user something easier to grip with the user's fingers when attaching or detaching the apparatus from a container stopper. A similar shape that provides a “blade” or “fin” structure of sorts is a “wing-nut”shape. FIGS. 7 and 8 depict one example of such an embodiment. In this particular case, the wing-nut-shaped, oxygen-scavenging member 10 is manufactured to maximize surface-area exposure, with each “wing” being folded back on itself but allowing fluids direct access to surfaces within the folds. Of course, in many embodiments, a simple wing-nut-shaped, oxygen-scavenging member 10 that does not have folds in each “wing” might be used, as such a shape would be easier to manufacture while still presenting adequate oxygen-absorption capabilities. It should be noted that any reference to a “blade” or “fin” structure in this application generally refers to any structure formed from the base of the oxygen-scavenging member 7, 8, 9, 10 that forms one or more planar-like appendages from said base, such that increased surface area for the oxygen-scavenging member 7, 8, 9, 10 is realized.

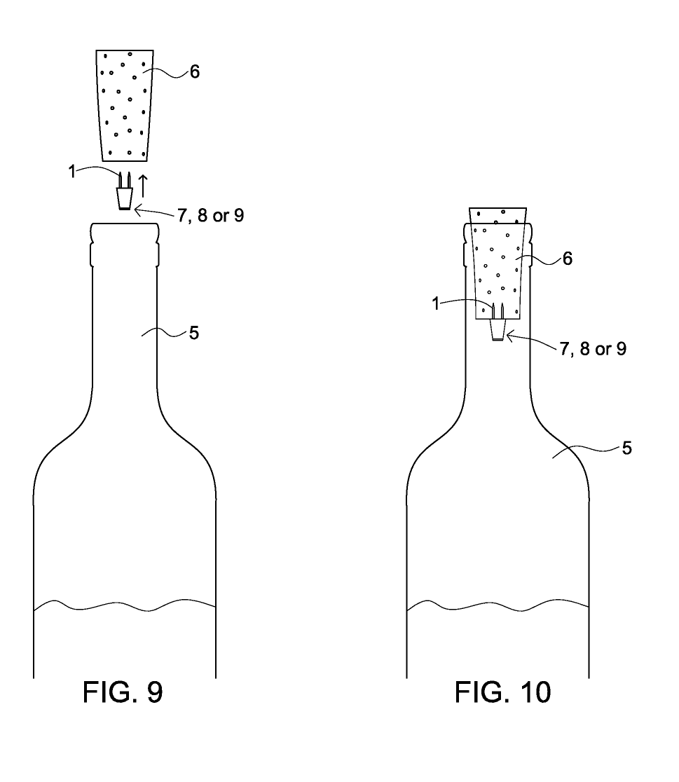

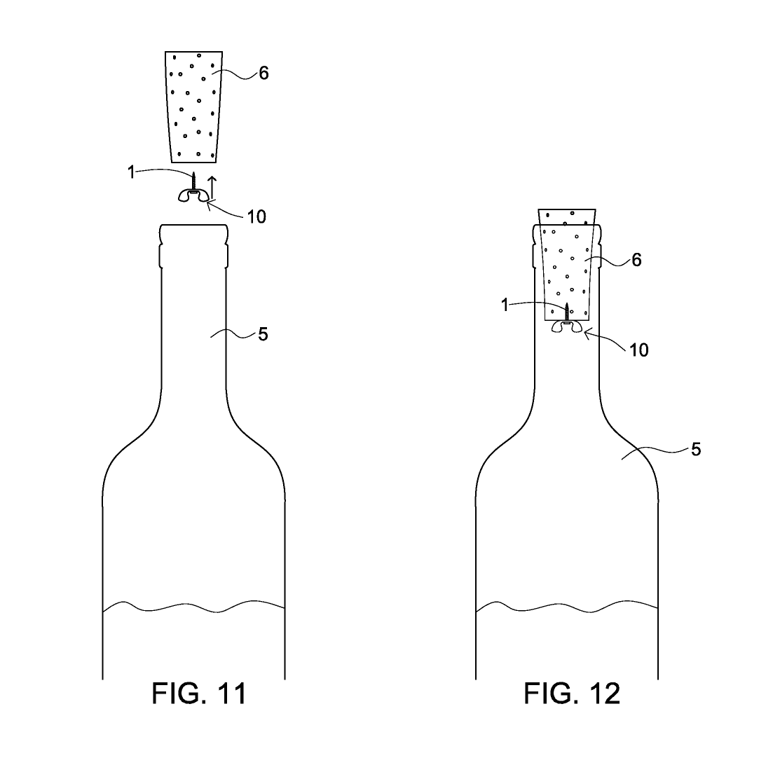

Refer to FIGS. 9-12. To use the oxygen-scavenging apparatus, a user merely attaches the apparatus to the “bottom” (to be more precise, the container-interior 5 side) of the container stopper 6, which in the case of a bottle of wine 5 is often a traditional cork 6. Friction-based fastener-end members 1 are frictionally inserted into the container stopper 6, preferably until the base of the oxygen-scavenging member 7, 8, 10 is seated against the “bottom’ of the container stopper 6.

In some embodiments, however, the fastener-end member 1 is merely a food-safe adhesive material that a user can enable by peeling-off a protective packaging layer of the adhesive member that is attached to the oxygen-scavenging member 10. The user can then simply attach the oxygen-scavenging apparatus to the bottom of the container stopper 6 with mild force to enable the adhesion of the oxygen-scavenging apparatus to the container stopper 6.

Once the attachment is accomplished, the user can reinsert the container stopper 6, which has the oxygen-scavenging apparatus attached at the “bottom”, into the container 5. The oxygen-scavenging member 7, 8, 9, 10 will then interact with any molecular oxygen in the gaseous portions of the contents of the container 5, thus increasing the shelf life of the food or beverage being stored in the container 5. Wine is especially suited for this device.

In some embodiments, if the oxygen-scavenging apparatus is equipped with an oxygen-indicator member 11, then assuming that the container allows a user to view any color changes of the oxygen-indicator member 11 and determine that the oxygen-scavenging apparatus is used up (due to the indication of excess molecular oxygen), then the user can replace the oxygen-scavenging apparatus with a fresh one.

### Second Embodiment

### A Method for Making an Apparatus for Scavenging Oxygen in a Partially Used, Resealed Container of Food or Beverage

This embodiment is directed generally to a method of making an easily installed and removable oxygen-scavenging device that is affixed to stopper, such as a cork, of a bottle of wine. Refer to FIGS. 1-12.

The method comprises the steps of: providing an oxygen-scavenging member 7, 8, 9, 10; and providing a fastener-end member 1, wherein the oxygen-scavenging member 7, 8, 9, 10 is coupled to the fastener-end member 1, thus forming the oxygen-scavenging apparatus, wherein the oxygen-scavenging member 7, 8, 9, 10 is adapted to allow a user to exert force on the oxygen-scavenging member 7, 8, 9, 10 to cause the fastener-end member 1 to be detachably coupled by a user to the inside surface of the container 5 stopper 6 and to be secured in place after the container 5 stopper 6 is sealably coupled with the container 5, and wherein the oxygen-scavenging apparatus 7, 8, 9, 10 is adapted to not breach the integrity of said container 5 stopper 6 with respect to the atmosphere outside the container 5 when the fastener-end member 1 is fully engaged with the container 5 stopper 6.

This embodiment can be further extended wherein said fastener-end member 1 is of friction type.

This embodiment can be further extended wherein said fastener-end member 1 is selected from the group comprising a tack-type fastener, a wood-screw-type fastener, and a cork-screw-type fastener.

This embodiment can be further extended wherein said fastener-end member 1 is comprised of an adhesive.

This embodiment can be further extended wherein the oxygen-scavenging member 7, 8, 9, 10 is substantially comprised of an oxygen-scavenging compound 2.

This embodiment can be further extended wherein the oxygen-scavenging compound 2 is incorporated within a polymer to substantially comprise the body of the oxygen-scavenging member 7, 8, 9, 10.

This embodiment can be further extended by further comprising the step of providing the oxygen-scavenging compound 2 of the oxygen-scavenging member 7, 8, 9, 10 with a coating of a gas-permeable, liquid-impermeable layer 3, whereby the gas-permeable, liquid-impermeable layer 3 prevents bleed-out of oxygen-scavenging-compound 2 material into the contents of the container 5, and whereby gases in the container 5, including molecular oxygen, are allowed to chemically interact with the oxygen-scavenging compound 2.

This embodiment can be further extended wherein the oxygen-scavenging member 10 is shaped to have at least one blade extending from the center of the oxygen-scavenging member 10, whereby the at least one blade increases the absorption surface area of the oxygen-scavenging member 10, thus increasing its effectiveness.

This embodiment can be further extended wherein the oxygen-scavenging member 7, 8, 9, 10 comprises a casing with an internal chamber and oxygen-scavenging compound 2 within the chamber, wherein the casing has perforations leading to the chamber containing the oxygen-scavenging compound 2, and whereby gases are able to chemically interact with the oxygen-scavenging compound 2 by way of the perforations. Further, in other variations, the chamber can comprise desiccant material within the chamber, whereby the desiccant material absorbs moisture from within the gaseous portion of the contents of the container 5. In other enhancements, a second internal chamber is included within the casing, and desiccant material is disposed within the second chamber, whereby the desiccant material absorbs moisture from within the gaseous portion of the contents of the container 5.

This embodiment can be further enhanced wherein the oxygen-scavenging member 7, 8, 9, 10 chamber is adapted to be openable and resealable to facilitate the replacement of depleted oxygen-scavenging compound and/or depleted desiccant material.

This embodiment can be enhanced by further comprising the step of providing, on the oxygen-scavenging member 7, 8, 9, 10, an oxygen-indicator member 11, wherein the oxygen-indicator member 11 is comprised of a food-safe compound, and wherein the oxygen-indicator member 11 changes color as the concentration of molecular oxygen in the gaseous environment surrounding the oxygen-indicator member 11 increases.

### Third Embodiment

### A Method for Using an Apparatus for Scavenging Oxygen in a Partially Used, Resealed Container of Food or Beverage

This embodiment is directed generally to a method of using an easily installed and removable oxygen-scavenging device that is affixed to stopper, such as a cork, of a bottle of wine. Refer to FIGS. 1-12.

The method comprises the steps of: obtaining an oxygen-scavenging apparatus 7, 8, 9, according to the First Embodiment described supra, opening the container 5 by removing the container 5 stopper 6; installing the oxygen-scavenging apparatus 7, 8, 9, 10 onto the stopper 6, using said fastener-end member 1 of the oxygen-scavenging apparatus 7, 8, 9, 10 to engage the container 5 stopper 6 on the side of the container 5 stopper 6 that interfaces with the interior of the container 5 when the container 5 stopper 6 is sealably coupled with the container 5, wherein the fastener-end member 1 is inserted into (if of friction type) or adhesively attached to (if of adhesive type) the container 5 stopper 6 such that the fastener-end member 1 is securely, but detachably, fixed to the container 5 stopper 6; and sealably recoupling the container 5 stopper 6 into the container 5, thereby providing a means to scavenge oxygen within the resealed container 5 and help preserve the contents of the container 5.

This embodiment can be further extended wherein said fastener-end member 1 is of friction type.

This embodiment can be further extended wherein said fastener-end member 1 is selected from the group comprising a tack-type fastener, a wood-screw-type fastener, and a cork-screw-type fastener.

This embodiment can be further extended wherein said fastener-end member 1 is comprised of an adhesive.

This embodiment can be further extended wherein the oxygen-scavenging member 7, 8, 9, 10 is substantially comprised of an oxygen-scavenging compound 2.

This embodiment can be further extended wherein the oxygen-scavenging compound 2 is incorporated within a polymer to substantially comprise the body of the oxygen-scavenging member 7, 8, 9, 10.

This embodiment can be further extended wherein the oxygen-scavenging compound 2 of the oxygen-scavenging member 7, 8, 9, 10 is coated with a gas-permeable, liquid-impermeable layer 3, whereby the gas-permeable, liquid-impermeable layer 3 prevents bleed-out of oxygen-scavenging-compound 2 material into the contents of the container 5, and whereby gases in the container 5, including molecular oxygen, are allowed to chemically interact with the oxygen-scavenging compound 2.

This embodiment can be further extended wherein the oxygen-scavenging member 10 is shaped to have at least one blade extending from the center of the oxygen-scavenging member 10, whereby the at least one blade increases the absorption surface area of the oxygen-scavenging member 10, thus increasing its effectiveness.

This embodiment can be further extended wherein the at least one blade extending from the center of the oxygen-scavenging member 10 is adapted to withstand the torque of a user grasping the at least one blade while inserting the fastener-end member 1 of the oxygen-scavenging apparatus into the container 5 stopper 6, further comprising the step of grasping the at least one blade while inserting the fastener-end member 1 of the oxygen-scavenging apparatus into the container 5 stopper 6. This enhancement can be further varied wherein the fastener-end member 1 is selected from the group comprising a wood-screw-type fastener and a cork-screw-type fastener, further comprising the step of exerting rotational torque while grasping the at least one blade and while inserting the fastener-end member 1 of the oxygen-scavenging apparatus into the container 5 stopper b6 in order to insertably engage the screw-type fastener-end member 1 with container-stopper 6 material.

This embodiment can be further extended wherein the oxygen-scavenging member 7, 8, 9, 10 comprises a casing with an internal chamber and oxygen-scavenging compound 2 within the chamber, wherein the casing has perforations leading to the chamber containing the oxygen-scavenging compound 2, and whereby gases are able to chemically interact with the oxygen-scavenging compound 2 by way of the perforations. Further, in other variations, the chamber can comprise desiccant material within the chamber, whereby the desiccant material absorbs moisture from within the gaseous portion of the contents of the container 5. In other enhancements, a second internal chamber is included within the casing, and desiccant material is disposed within the second chamber, whereby the desiccant material absorbs moisture from within the gaseous portion of the contents of the container 5.

This embodiment can be further enhanced wherein the oxygen-scavenging member 7, 8, 9, 10 chamber is adapted to be openable and resealable to facilitate the replacement of depleted oxygen-scavenging compound and/or depleted desiccant material, with the method further comprising the steps, if necessary to replace oxygen-scavenging compound and/or desiccant material, of: opening the internal chamber; removing depleted oxygen-scavenging compound and/or desiccant material from the internal chamber; installing non-depleted oxygen-scavenging compound and/or desiccant material in the internal chamber; and resealing said internal chamber.

This embodiment can be further enhanced, wherein the oxygen-scavenging member 7, 8, 9, 10 further comprises an oxygen-indicator member 11, wherein the oxygen-indicator member 11 is comprised of a food-safe compound, and wherein the oxygen-indicator member 11 changes color as the concentration of molecular oxygen in the gaseous environment surrounding the oxygen-indicator member 11 increases. The method of this enhancement further comprises the steps of: observing a color change on the oxygen-indicator member 11, the color change indicating an increase in molecular-oxygen concentration within the gaseous contents of the container 5; removing the container stopper 6; removing the installed oxygen-scavenging apparatus 7, 8, 9, 10 from the container stopper 6; installing a new oxygen-scavenging apparatus 7, 8, 9, 10 onto the container stopper 6, using the fastener-end member 1 of the new oxygen-scavenging apparatus 7, 8, 9, 10 to engage the container stopper 6 on the side of the container stopper 6 that interfaces with the interior of the container 5 when the container stopper 6 is sealably coupled with the container 5; and sealably recoupling the container stopper 6 into the container 5. If the fastener-end member 1 is of friction type, then the fastener-end member 1 is inserted into the container stopper 6 such that the fastener-end member 1 is securely, but detachably, fixed to the container stopper 6. If the fastener-end member 1 is of adhesive type, then the fastener-end member 1 is adhesively attached to the container stopper 6 such that the fastener-end member 1 is securely, but detachably, fixed to the container stopper 6. Thus, continuous/renewed oxygen scavenging is enabled.

This embodiment can be further enhanced, wherein the oxygen-scavenging member 7, 8, 9, 10 further comprises an oxygen-indicator member 11, wherein the oxygen-indicator member 11 is comprised of a food-safe compound, wherein the oxygen-indicator member 11 changes color as the concentration of molecular oxygen in the gaseous environment surrounding the oxygen-indicator member 11 increases, and wherein the oxygen-scavenging member has at least one internal chamber used to house oxygen-scavenging compound and/or desiccant material. The method of this enhancement further comprises the steps of: observing a color change on the oxygen-indicator member 11, the color change indicating an increase in molecular-oxygen concentration within the gaseous contents of the container 5; removing the container stopper 6; removing the installed oxygen-scavenging apparatus 7, 8, 9, 10 from the container stopper 6; removing existing oxygen-scavenging compound 2 and/or desiccant material from the chamber; installing new oxygen-scavenging compound and/or desiccant material within said chamber; reinstalling the oxygen-scavenging apparatus 7, 8, 9, 10 onto the container stopper 6, using the fastener-end member 1 of the new oxygen-scavenging apparatus 7, 8, 9, 10 to engage the container stopper 6 on the side of the container stopper 6 that interfaces with the interior of the container 5 when the container stopper 6 is sealably coupled with the container 5; and sealably recoupling the container stopper 6 into the container 5. If the fastener-end member 1 is of friction type, then the fastener-end member 1 is inserted into the container stopper 6 such that the fastener-end member 1 is securely, but detachably, fixed to the container stopper 6. If the fastener-end member 1 is of adhesive type, then the fastener-end member 1 is adhesively attached to the container stopper 6 such that the fastener-end member 1 is securely, but detachably, fixed to the container stopper 6. Thus, continuous/renewed oxygen scavenging is enabled.

### ALTERNATIVE EMBODIMENTS AND OTHER VARIATIONS

The various embodiments and variations thereof described herein and/or illustrated in the accompanying Figures are merely exemplary and are not meant to limit the scope of the inventive disclosure. It should be appreciated that numerous variations of the invention have been contemplated as would be obvious to one of ordinary skill in the art with the benefit of this disclosure.

Hence, those ordinarily skilled in the art will have no difficulty devising myriad obvious variations and improvements to the invention, all of which are intended to be encompassed within the scope of the claims which follow.

What is claimed is:

1. An oxygen-scavenging apparatus for use with a container stopper adapted for a food and/or beverage container, comprising:
an oxygen-scavenging member; and
a fastener-end member,
wherein said oxygen-scavenging member is coupled to said fastener-end member, thus forming said oxygen-scavenging apparatus,
wherein said oxygen-scavenging member is adapted to allow a user to exert force on said oxygen-scavenging member to cause said fastener-end member to be detachably coupled by a user to the inside surface of said container stopper and to be secured in place after said container stopper is sealably coupled with said container, and
wherein said oxygen-scavenging apparatus is adapted to not breach the integrity of said container stopper with respect to the atmosphere outside said container when said fastener-end member is fully engaged with said container stopper.

2. The oxygen-scavenging apparatus of claim 1, wherein said fastener-end member is of friction type.

3. The oxygen-scavenging apparatus of claim 2, wherein said fastener-end member is selected from the group comprising a tack-type fastener, a wood-screw-type fastener, and a cork-screw-type fastener.

4. The oxygen-scavenging apparatus of claim 1, wherein said fastener-end member is comprised of an adhesive.

5. The oxygen-scavenging apparatus of claim 1, wherein said oxygen-scavenging member is substantially comprised of an oxygen-scavenging compound.

6. The oxygen-scavenging apparatus of claim 5, wherein said oxygen-scavenging compound is incorporated within a polymer to substantially comprise the body of said oxygen-scavenging member.

7. The oxygen-scavenging apparatus of claim 5, wherein said oxygen-scavenging compound of said oxygen-scavenging member is coated with a gas-permeable, liquid-impermeable layer,
whereby said gas-permeable, liquid-impermeable layer prevents bleed-out of oxygen-scavenging-compound material into the contents of said container, and
whereby gases in said container, including molecular oxygen, are allowed to chemically interact with said oxygen-scavenging compound.

8. The oxygen-scavenging apparatus of claim 1, wherein said oxygen-scavenging member is shaped to have at least one blade extending from the center of said oxygen-scavenging member,
whereby said at least one blade increases the absorption surface area of said oxygen-scavenging member, thus increasing its effectiveness.

9. The oxygen-scavenging apparatus of claim 5, wherein said oxygen-scavenging member comprises:
a casing with an internal chamber; and
oxygen-scavenging compound within said chamber,
wherein said casing has perforations leading to said chamber containing said oxygen-scavenging compound;
whereby gases are able to chemically interact with said oxygen-scavenging compound by way of said perforations.

10. The oxygen-scavenging apparatus of claim 9, wherein said oxygen-scavenging member further comprises:
desiccant material within said chamber,
whereby said desiccant material absorbs moisture from within the gaseous portion of the contents of said container.

11. The oxygen-scavenging apparatus of claim 9, wherein said oxygen-scavenging member further comprises:
a second internal chamber within said casing; and
desiccant material within said second chamber,
whereby said desiccant material absorbs moisture from within the gaseous portion of the contents of said container.

12. The oxygen-scavenging apparatus of claim 9, wherein said oxygen-scavenging member chamber is adapted to be openable and resealable to facilitate the replacement of depleted oxygen-scavenging compound.

13. The oxygen-scavenging apparatus of claim 9, wherein said oxygen-scavenging member chamber is adapted to be openable and resealable to facilitate the replacement of depleted desiccant material.

14. The oxygen-scavenging apparatus of claim 1, wherein said oxygen-scavenging member further comprises an oxygen-indicator member,
wherein said oxygen-indicator member is comprised of a food-safe compound, and
wherein said oxygen-indicator member changes color as the concentration of molecular oxygen in the gaseous environment surrounding said oxygen-indicator member increases.

15. A method for making an oxygen-scavenging apparatus for use with a container stopper adapted for a food and/or beverage container, comprising the steps of:
providing an oxygen-scavenging member; and
providing a fastener-end member,
wherein said oxygen-scavenging member is coupled to said fastener-end member, thus forming said oxygen-scavenging apparatus,
wherein said oxygen-scavenging member is adapted to allow a user to exert force on said oxygen-scavenging member to cause said fastener-end member to be detachably coupled by a user to the inside surface of said container stopper and to be secured in place after said container stopper is sealably coupled with said container, and
wherein said oxygen-scavenging apparatus is adapted to not breach the integrity of said container stopper with respect to the atmosphere outside said container when said fastener-end member is fully engaged with said container stopper.

16. The method of claim 15, wherein said fastener-end member is of friction type.

17. The method of claim 16, wherein said fastener-end member is selected from the group comprising a tack-type fastener, a wood-screw-type fastener, and a cork-screw-type fastener.

18. The method of claim 15, wherein said fastener-end member is comprised of an adhesive.

19. The method of claim 15, wherein said oxygen-scavenging member is substantially comprised of an oxygen-scavenging compound.

20. The method of claim 19, wherein said oxygen-scavenging compound is incorporated within a polymer to substantially comprise the body of said oxygen-scavenging member.

21. The method of claim 19, further comprising the step of providing said oxygen-scavenging compound of said oxygen-scavenging member with a coating of a gas-permeable, liquid-impermeable layer,
whereby said gas-permeable, liquid-impermeable layer prevents bleed-out of oxygen-scavenging-compound material into the contents of said container, and
whereby gases in said container, including molecular oxygen, are allowed to chemically interact with said oxygen-scavenging compound.

22. The method of claim 15, wherein said oxygen-scavenging member is shaped to have at least one blade extending from the center of said oxygen-scavenging member,
whereby said at least one blade increases the absorption surface area of said oxygen-scavenging member, thus increasing its effectiveness.

23. The method of claim 19, wherein said oxygen-scavenging member comprises:
a casing with an internal chamber; and
oxygen-scavenging compound within said chamber,
wherein said casing has perforations leading to said chamber containing said oxygen-scavenging compound;
whereby gases are able to chemically interact with said oxygen-scavenging compound by way of said perforations.

24. The method of claim 19, wherein said oxygen-scavenging member further comprises:
desiccant material within said chamber,
whereby said desiccant material absorbs moisture from within the gaseous portion of the contents of said container.

25. The method of claim 19, wherein said oxygen-scavenging member further comprises:
a second internal chamber within said casing; and
desiccant material within said second chamber,
whereby said desiccant material absorbs moisture from within the gaseous portion of the contents of said container.

26. The method of claim 19, wherein said oxygen-scavenging member chamber is adapted to be openable and resealable to facilitate the replacement of depleted oxygen-scavenging compound.

27. The method of claim 19, wherein said oxygen-scavenging member chamber is adapted to be openable and resealable to facilitate the replacement of depleted desiccant material.

28. The method of claim 15, further comprising the step of providing on said oxygen-scavenging member an oxygen-indicator member,
wherein said oxygen-indicator member is comprised of a food-safe compound, and
wherein said oxygen-indicator member changes color as the concentration of molecular oxygen in the gaseous environment surrounding said oxygen-indicator member increases.

29. A method for using an oxygen-scavenging apparatus for use with a container stopper adapted for a food and/or beverage container, comprising the steps of:
obtaining an oxygen-scavenging apparatus according to claim 1;
opening said container by removing said container stopper;
installing said oxygen-scavenging apparatus onto said container stopper, using said fastener-end member of said oxygen-scavenging apparatus to engage said container stopper on the side of said container stopper that interfaces with the interior of said container when said container stopper is sealably coupled with said container,
wherein if said fastener-end member is of friction type, then said fastener-end member is inserted into said container stopper such that said fastener-end member is securely, but detachably, fixed to said container stopper, and
wherein if said fastener-end member is of adhesive type, then said fastener-end member is adhesively attached to said container stopper such that said fastener-end member is securely, but detachably, fixed to said container stopper; and
sealably recoupling said container stopper into said container,
thereby providing a means to scavenge oxygen within said resealed container and help preserve the contents of said container.

30. The method of claim 29, wherein said fastener-end member is of friction type.

31. The method of claim 30, wherein said fastener-end member is selected from the group comprising a tack-type fastener, a wood-screw-type fastener, and a cork-screw-type fastener.

32. The method of claim 29, wherein said fastener-end member is comprised of an adhesive.

33. The method of claim 29, wherein said oxygen-scavenging member is substantially comprised of an oxygen-scavenging compound.

34. The method of claim 33, wherein said oxygen-scavenging compound is incorporated within a polymer to substantially comprise the body of said oxygen-scavenging member.

35. The method of claim 34, wherein said oxygen-scavenging compound of said oxygen-scavenging member is coated with a gas-permeable, liquid-impermeable layer,
whereby said gas-permeable, liquid-impermeable layer prevents bleed-out of oxygen-scavenging-compound material into the contents of said container, and
whereby gases in said container, including molecular oxygen, are allowed to chemically interact with said oxygen-scavenging compound.

36. The method of claim 29, wherein said oxygen-scavenging member is shaped to have at least one blade extending from the center of said oxygen-scavenging member,
whereby said at least one blade increases the absorption surface area of said oxygen-scavenging member, thus increasing its effectiveness.

37. The method of claim 36, wherein said at least one blade extending from the center of said oxygen-scavenging member is adapted to withstand the torque of a user grasping said at least one blade while inserting said fastener-end member of said oxygen-scavenging apparatus into said container stopper, further comprising the step of:
grasping said at least one blade while inserting said fastener-end member of said oxygen-scavenging apparatus into said container stopper.

38. The method of claim 37, wherein said fastener-end member is selected from the group comprising a wood-screw-type fastener and a cork-screw-type fastener, further comprising the step of:
exerting rotational torque while grasping said at least one blade and while inserting said fastener-end member of said oxygen-scavenging apparatus into said container stopper in order to insertably engage said screw-type fastener-end member with container-stopper material.

39. The method of claim 33, wherein said oxygen-scavenging member comprises:
a casing with an internal chamber; and
oxygen-scavenging compound within said chamber,
wherein said casing has perforations leading to said chamber containing said oxygen-scavenging compound;
whereby gases are able to chemically interact with said oxygen-scavenging compound by way of said perforations.

40. The method of claim 39, wherein said oxygen-scavenging member further comprises:
desiccant material within said chamber,
whereby said desiccant material absorbs moisture from within the gaseous portion of the contents of said container.

41. The method of claim 39, wherein said oxygen-scavenging member further comprises:
a second internal chamber within said casing; and
desiccant material within said second chamber,
whereby said desiccant material absorbs moisture from within the gaseous portion of the contents of said container.

42. The method of claim 39, wherein said oxygen-scavenging member chamber is adapted to be openable and resealable to facilitate the replacement of depleted oxygen-scavenging compound, the method further comprising the steps, if necessary to replace depleted oxygen-scavenging compound, of:
opening said internal chamber;
removing depleted oxygen-scavenging compound from said internal chamber;
installing non-depleted oxygen-scavenging compound in said internal chamber; and
resealing said internal chamber.

43. The method of claim 39, wherein said oxygen-scavenging member chamber is adapted to be openable and resealable to facilitate the replacement of depleted desiccant material, the method further comprising the steps, if necessary to replace depleted desiccant material, of:
opening said internal chamber;
removing depleted desiccant material from said internal chamber;
installing non-depleted desiccant material in said internal chamber; and
resealing said internal chamber.

44. The method of claim 29, wherein said oxygen-scavenging member further comprises an oxygen-indicator member,
wherein said oxygen-indicator member is comprised of a food-safe compound, and
wherein said oxygen-indicator member changes color as the concentration of molecular oxygen in the gaseous environment surrounding said oxygen-indicator member increases;
the method further comprising the steps of:
observing a color change on said oxygen-indicator member, said color change indicating an increase in molecular-oxygen concentration within the gaseous contents of said container;
removing said container stopper;
removing said installed oxygen-scavenging apparatus from said container stopper;
installing a new oxygen-scavenging apparatus onto said container stopper, using said fastener-end member of said new oxygen-scavenging apparatus to engage said container stopper on the side of said container stopper that interfaces with the interior of said container when said container stopper is sealably coupled with said container,
wherein if said fastener-end member is of friction type, then said fastener-end member is inserted into said container stopper such that said fastener-end member is securely, but detachably, fixed to said container stopper, and
wherein if said fastener-end member is of adhesive type, then said fastener-end member is adhesively attached to said container stopper such that said fastener-end member is securely, but detachably, fixed to said container stopper; and
sealably recoupling said container stopper into said container,
thereby continuing to provide a means to scavenge oxygen within said resealed container and help preserve the contents of said container.

45. The method of claim 39, wherein said oxygen-scavenging member further comprises an oxygen-indicator member,
wherein said oxygen-indicator member is comprised of a food-safe compound, and
wherein said oxygen-indicator member changes color as the concentration of molecular oxygen in the gaseous environment surrounding said oxygen-indicator member increases;
the method further comprising the steps of:
observing a color change on said oxygen-indicator member, said color change indicating an increase in molecular-oxygen concentration within the gaseous contents of said container;
removing said container stopper;
removing said installed oxygen-scavenging apparatus from said container stopper;
removing existing oxygen-scavenging compound from said chamber;
installing new oxygen-scavenging compound within said chamber;
reinstalling said oxygen-scavenging apparatus onto said container stopper, using said fastener-end member of said oxygen-scavenging apparatus to engage said container stopper on the side of said container stopper that interfaces with the interior of said container when said container stopper is sealably coupled with said container,
wherein if said fastener-end member is of friction type, then said fastener-end member is inserted into said container stopper such that said fastener-end member is securely, but detachably, fixed to said container stopper, and
wherein if said fastener-end member is of adhesive type, then said fastener-end member is adhesively attached to said container stopper such that said fastener-end member is securely, but detachably, fixed to said container stopper; and
sealably recoupling said container stopper into said container,
thereby continuing to provide a means to scavenge oxygen within said resealed container and help preserve the contents of said container.
